(19) United States
(12) Patent Application Publication
(10) Pub. No.: US 2017/0180490 A1
(43) Pub. Date: Jun. 22, 2017

(54) PRE-QUALIFYING REGISTRANTS FOR RESTRICTED TLDs

(71) Applicant: GO DADDY OPERATING COMPANY, LLC, SCOTTSDALE, AZ (US)

(72) Inventors: TAPAN KAMDAR, SAN JOSE, CA (US); NITIN GUPTA, MOUNTAINVIEW, CA (US)

(21) Appl. No.: 14/979,040

(22) Filed: Dec. 22, 2015

(51) Int. Cl. H04L 29/08; H04L 29/12; H04W 4/02

(52) U.S. Cl. CPC H04L 67/18; H04W 4/021; H04L 61/1511; H04L 61/2007

(57) ABSTRACT

A registrar may use a geographic location of a potential domain name registrant, history data of other domain name requesters requesting to register restricted domain names, account information and/or previous restricted domain names registered by the potential domain name registrant to predict whether or not the potential domain name registrant will qualify for a suggested restricted domain name. If predicted to qualify, the registrar may transmit the suggested restricted domain name to the potential domain name registrant. The registrar may receive a request from the potential domain name registrant to register the suggested restricted domain name. The registrar may collect additional information to qualify the potential domain name registrant either before or after the purchase of the suggested restricted domain name. If the potential domain name registrant qualifies for the suggested restricted domain name, the registrar may register the suggested restricted domain name to the potential domain name registrant.

### FIELD OF THE INVENTION

The present invention generally relates to a method of predicting whether a potential domain name registrant will qualify to register a restricted domain name and only suggesting the restricted domain name for domain name registration if it is predicted that the potential domain name registrant will be able to qualify to register the restricted domain name.

### SUMMARY OF THE INVENTION

In an example embodiment, a domain name registrar may have history data of previous domain name requesters requesting restricted domain names. The history data may include the geographic locations of the previous domain name requesters (as non-limiting examples, by country, city and/or area code) and which restricted domain names (or their TLDs) they were able to qualify for and which restricted domain names (or their TLDs) they were not able to qualify for. The domain name registrar may also have customer account information for customers. The customer account information may include addresses (such as billing addresses) and/or data regarding which restricted domain names (or their TLDs) a customer (a potential domain name registrant) was able to qualify for and which restricted domain names (or their TLDs) a customer was not able to qualify for. The domain name registrar may be connected, via the Internet and/or a cell phone network, to the potential domain name registrant operating a client device. The domain name registrar may be able to identify an IP address and/or a cell phone number used by the client device.

In another embodiment, a domain name registrar may use a domain name search request and/or a geographic location of a potential domain name registrant (or her client device) to predict whether the potential domain name registrant will qualify for a suggested restricted domain name. If the potential domain name registrant is predicted to qualify for the suggested restricted domain name, the domain name registrar may transmit the suggested restricted domain name to the potential domain name registrant for domain name registration. If the potential domain name registrant is predicted to not to be able to qualify for the suggested restricted domain name, the suggested restricted domain name is not suggested to the potential domain name registrant for domain name registration.

In another embodiment, a domain name registrar may use a geographic location of a potential domain name registrant (or her client device) and history data comprising a success and/or a failure data of a plurality of past domain name requesters at the geographic location of the potential domain name registrant in registering a plurality of restricted domain names (or their TLDs) to predict whether the potential domain name registrant will qualify for a suggested restricted domain name. If the potential domain name registrant is predicted to qualify for the suggested restricted domain name, the domain name registrar may transmit the suggested restricted domain name to the potential domain name registrant for domain name registration.

In another embodiment, a domain name registrar may use one or more previous restricted domain names (or their TLDs) registered by the potential domain name registrant and/or other potential domain name registrant account information to predict whether the potential domain name registrant will qualify to register a suggested restricted domain name. If the potential domain name registrant is predicted to qualify for the suggested restricted domain name, the domain name registrar may transmit the suggested restricted domain name to the potential domain name registrant for domain name registration.

If the suggested restricted domain name was transmitted to the potential domain name registrant, the domain name registrar may receive a request from the potential domain name registrant to register the suggested restricted domain name.

In an example embodiment, the domain name registrar may collect additional information from the potential domain name registrant to qualify the potential domain name registrant for registering the suggested restricted domain name. If the potential domain name registrant qualifies for the suggested restricted domain name, the domain name registrar may complete a purchase transaction with the potential domain name registrant and the domain name registrar may register the suggested restricted domain name to the potential domain name registrant.

In another embodiment, the domain name registrar may complete a purchase transaction with the potential domain name registrant before collecting additional information from the potential domain name registrant to qualify for the suggested restricted domain name. Only after completing the purchase transaction in this embodiment, the domain name registrar may collect additional information from the potential domain name registrant to qualify the potential domain name registrant for registering the suggested restricted domain name. If the potential domain name registrant qualifies for the suggested restricted domain name, the domain name registrar may register the suggested restricted domain name to the potential domain name registrant. If the potential domain name registrant does not qualify for the suggested restricted domain name, the domain name registrar may reverse the purchase of the suggested restricted domain name with the potential domain name registrant.

The above features and advantages of the present invention will be better understood from the following detailed description taken in conjunction with the accompanying drawings.

### BRIEF DESCRIPTION OF THE DRAWINGS

FIG. 1 is a block diagram illustrating a domain name registrar which may include history data of other domain name requesters requesting restricted domain names and/or customer account information for customers (which may include a potential domain name registrant). The domain name registrar may be connected to the potential domain name registrant via the Internet and/or cell phone network.

FIG. 2 is a flow chart for a method of using a domain name search request and the geographic location of a potential domain name registrant or her client device to predict whether the potential domain name registrant will qualify for a suggested restricted domain name.

FIG. 3 is a flow chart for a method of using the geographic location of a potential domain name registrant or her client device and history data comprising a success and/or a failure data for a plurality of past domain name requesters at the geographic location of the potential domain name registrant in registering a plurality of restricted domain names to predict whether the potential domain name registrant will qualify for a suggested restricted domain name.

FIG. 4 is a flow chart for a method of using previous restricted domain names registered by the potential domain name registrant to predict whether the potential domain name registrant will qualify for a suggested restricted domain name.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

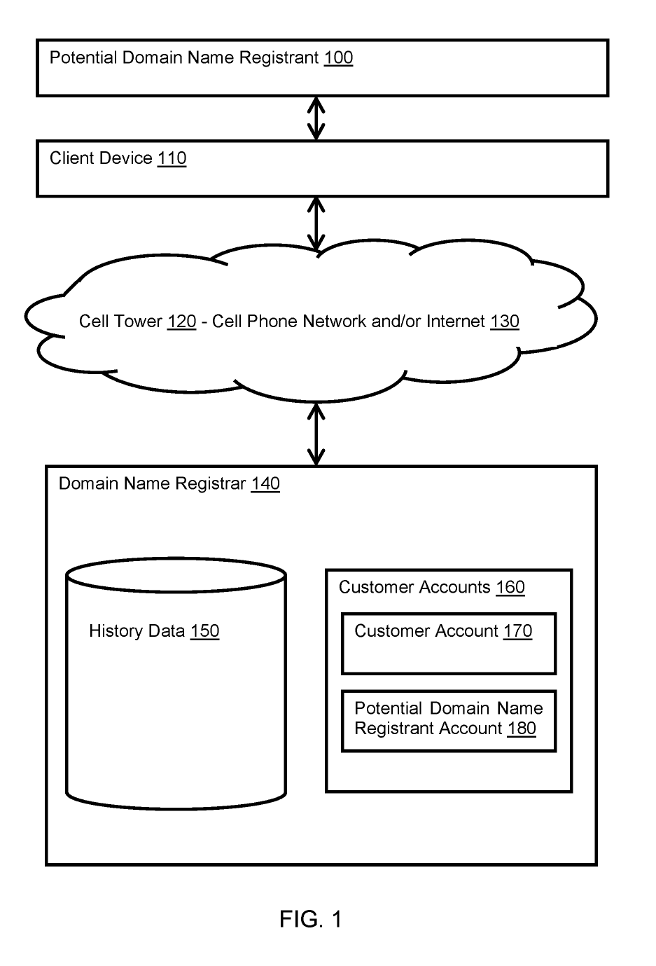

FIG. 1 illustrates a domain name registrar 140. The domain name registrar 140 may store history data 150 of other domain name requesters requesting restricted domain names. The domain name registrar 140 may also store customer account information for customers in a customer account 170. For purposes of this specification and claims, a potential domain name registrant 100 may be one of the customers of the domain name registrar 140. The domain name registrar 140 may be connected to the potential domain name registrant 100 via one or more computer networks, such as the Internet 130 and/or cell phone network.

The arrows between the domain name registrar 140, Internet 130 and cell phone network and client device 110 represent one or more computer networks. Communications and transmissions may use any currently known or developed in the future methods or protocols.

A computer network is a collection of links and nodes (e.g., multiple computers and/or other devices connected together) arranged so that information may be passed from one part of the computer network to another over multiple links and through various nodes. Non-limiting examples of computer networks include the Internet 130, a public switched telephone network, a global Telex network, an intranet, an extranet, a local-area network, a wide-area network, wired networks, wireless networks and cell phone networks.

The Internet 130 is a worldwide network of computers and computer networks arranged to allow the easy and robust exchange of information between computer users on client devices 110 (for purposes of this specification and specifically for the claims, the computer users or Internet users may be customers, potential domain name registrants 100 and past restricted domain name requesters) and websites hosted on servers (for purposes of this specification and specifically the claims, the websites hosted on servers may be one or more websites operated by a domain name registrar 140).

Hundreds of millions of people around the world have access to client devices 110 connected to the Internet 130 via Internet Service Providers (ISPs). Content providers may place multimedia information (e.g., text, graphics, audio, video, animation, and/or other forms of data) at specific locations on the Internet 130 referred to as websites. The combination of all the websites and their corresponding web pages on the Internet 130 is generally known as the World Wide Web (WWW) or simply the Web.

Websites may consist of a single webpage, but typically consist of multiple interconnected and related webpages. Websites, unless very large and complex or have unusual traffic demands, typically reside on a single server and are prepared and maintained by a single individual or entity (although websites residing on multiple servers are also becoming increasingly common). Menus, links, tabs, etc. may be used to move between different web pages within the website or to move to a different webpage on a different website.

Websites may be created using HyperText Markup Language (HTML) to generate a standard set of tags that define how the webpages for the website are to be displayed. Users of the Internet 130 may access content providers' websites using software known as an Internet browser, such as MICROSOFT INTERNET EXPLORER, GOOGLE CHROME or MOZILLA FIREFOX. After the browser has located the desired webpage, the browser requests and receives information from the webpage, typically in the form of an HTML document, and then displays the webpage content for the user on the user's client device 110. The user then may view other webpages at the same website or move to an entirely different website using the browser.

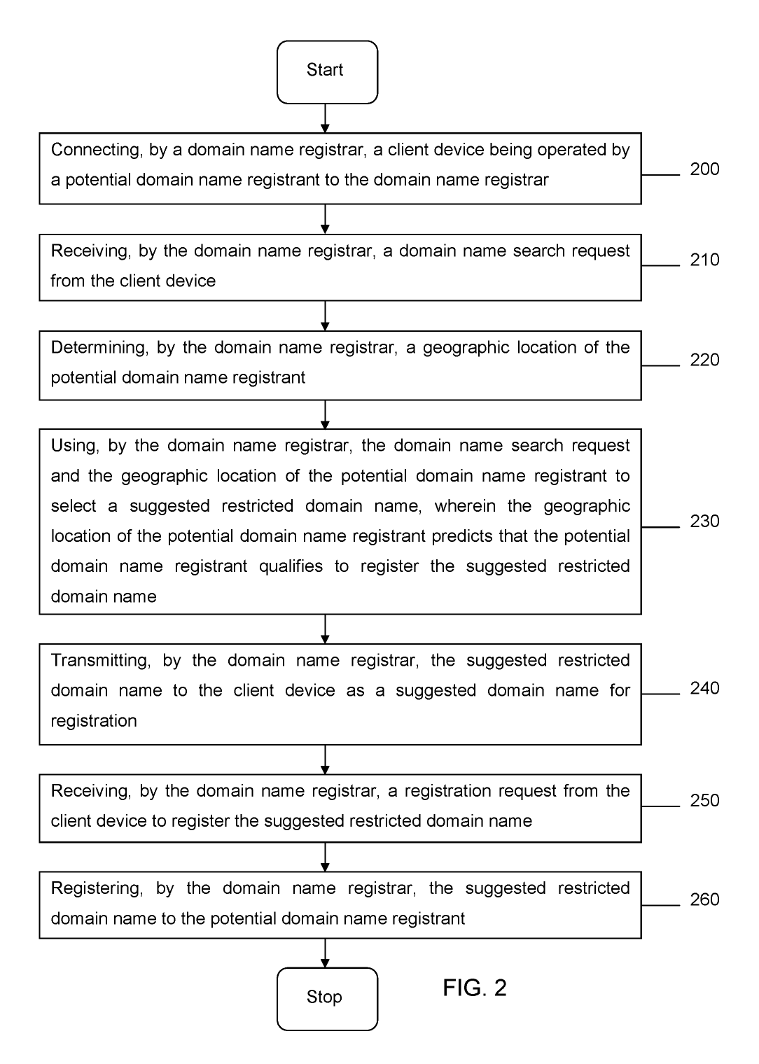

The Internet users may use a client device 110, such as, as non-limiting examples, a cell phone, PDA, tablet, laptop computer or desktop computer to access a website or server via a computer network. With reference to FIG. 2 and as a non-limiting example, a potential domain name registrant 100 may use a client device 110 to connect to a domain name registrar 140 via the Internet. (Step 200)

The website may have a plurality of webpages and be hosted or operated from one or more servers. The servers may be, as a non-limiting example, one or more Dell PowerEdge(s) rack server(s), HP Blade Servers, IBM Rack or Tower servers, although other types of servers, combinations of one or more servers, server software and applications may also be used.

Browsers are able to locate specific websites because each website, resource, and computer on the Internet 130 has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet 130. A browser is able to access a website on the Internet 130 through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) and the Internet Assigned Numbers Authority (IANA) create rules and coordinate the use of over 1,000 Top-Level Domains (TLDs). Each TLD is typically assigned a single registry to be an authoritative source of information (the particular data stored by the registry may vary depending on the TLD). One or more domain name registrars 140 may register domain names to domain name registrants on behalf of a registry.

The process for registering a domain name with .com, .net, .org, and some other TLDs allows an Internet user to use an ICANN-accredited domain name registrar 140 to register a domain name. For example, if a potential domain name registrant 100, John Doe, wishes to register the domain name “mycompany.com,” John Doe may initially determine whether the desired domain name is available by contacting a domain name registrar 140. As a non-limiting example, the potential domain name registrant 100 may make this contact using the registrar's webpage and typing the desired domain name into a field on the registrar's webpage created for this purpose. The domain name registrar 140 may be connected to the client device 110 and receive a domain name search request from the client device 110. The desired domain name may be considered a domain name search request. The domain name search request may also be one or more words, phrases, abbreviations, etc. that the domain name registrar 140 may use (as non-limiting examples, by combining in various orders and/or replacing parts of the domain name search request with synonyms) to create suggested domain names. The suggested domain names may include one or more suggested restricted domain names if the one or more suggested domain names are also restricted domain names. (Step 210)

Upon receiving the domain name search request from the potential domain name registrant 100, the registrar may ascertain whether “mycompany.com” has already been registered by checking the SRS database associated with the TLD of the domain name or by checking with the registry. The results of the search may be displayed on the webpage to thereby notify the potential domain name registrant 100 of the availability of the desired domain name. If the domain name is available, the potential domain name registrant 100 may proceed with the domain name registration process. If the desired domain name is not available for registration, the domain name registrar 140 may transmit one or more suggested domain names to the potential domain name registrant 100.

Some TLDs are referred to as open TLDs. These TLDs are not restricted and any person or entity may register a domain name with an open TLD. As non-limiting examples, .com, .org (although originally intended for use by non-profit organizations) and .net (although originally intended for use by domains pointing to a distributed network of computers) are currently open TLDs.

In contrast, TLDs that have one or more restriction requirements regarding who can register domain names having the TLD are herein defined as restricted TLDs and domain names having a restricted TLD are herein defined as a restricted domain name. Only potential domain name registrants 100 (persons or entities) that qualify, i.e., meet the registration restrictions, may register these restricted domain names. As non-limiting examples, the TLD .edu is restricted to specific educational institutions, the TLD .gov is restricted to United States governmental entities and qualifying state, county and local agencies and the TLD .mil is restricted to the United States military.

In addition, some country code TLDs (ccTLDs) have geographic restrictions. As non-limiting examples, the TLD .bm for the country Bermuda has a local corporate registration requirement, the TLD .ca for the country Canada has a Canadian presence requirement and the TLD .cn for the country China has a local company in China requirement or, for personal registrations, a valid Resident Identity Card requirement. These are non-limiting examples, as the present invention may be used in combination with many different domain name registration restrictions.

Domain name registrars 140 often suggest domain names to potential domain name registrants 100 to assist the potential domain name registrant 100 in finding a desirable domain name. However, transmitting a restricted domain name as a suggested domain name for registration (a suggested restricted domain name) to a client device 110 used by the potential domain name registrant 100 may cause problems. Specifically, if it turns out that the potential domain name registrant 100 does not qualify for the suggested restricted domain name, the potential domain name registrant 100 may blame the domain name registrar 140 for transmitting a suggested restricted domain name to the potential domain name registrant 100 that the potential domain name registrant 100 cannot actually register. This may damage the shopping experience and waste the time of the potential domain name registrant 100.

It is thus advantageous to pre-qualify potential domain name registrants 100 by predicting which restricted domain names or restricted TLDs the potential domain name registrants 100 are likely to qualify for, i.e., meet the restriction requirements. The domain name registrar 140 preferably only transmits suggested restricted domain names that the potential domain name registrant 100 is predicted to qualify for and specifically not transmit suggested restricted domain names that the potential domain name registrant 100 is predicted not to qualify for. Suggested restricted domain names are also preferably checked to make sure they are available (not already registered to a domain name registrant) before transmitting the suggested restricted domain name to the potential domain name registrant 100.

As previously discussed, some restricted TLDs have a geographic location restriction requirement. It is often useful for these restricted TLDs for the domain name registrar 140 to determine one or more geographic locations of the potential domain name registrant 100 (such as, as non-limiting examples, a country and a city). (Step 220)

Determining geographic locations of the potential domain name registrant 100 may be used to predict whether or not the potential domain name registrar 140 will qualify to register one or more restricted TLDs or restricted domain names. Determining the geographic location(s) of the potential domain name registrant 100 may be accomplished by any desired method or combination of methods.

As a non-limiting example of a method for determining a geographic location of the potential domain name registrant 100, the domain name registrar 140 may access a customer account 170 (in this case a potential domain name registrant account 180) of the potential domain name registrant 100 with the domain name registrar 140. The customer account 170 and potential domain name registrant account 180 may be just tow customer accounts in a plurality of customer accounts 160 stored and maintained by the domain name registrar 140. The domain name registrar 140 may read an address in the potential domain name registrant account 180 associated with the potential domain name registrant 100. This may be, as non-limiting examples, a billing address or a contact address. The domain name registrar 140 may then associate the address in the potential domain name registrant account 180 with a geographic location of the potential domain name registrant 100.

As another non-limiting example of a method for determining a geographic location of the potential domain name registrant 100, the domain name registrar 140 may determine a cell tower 120 used by the client device 110 in connecting to the domain name registrar 140. The domain name registrar 140 may determine, using known maps or tables of cell towers 120, a cell tower location for the cell tower 120 used by the client device 110. The domain name registrar 140 may then associate the cell tower location with a geographic location of the potential domain name registrant 100.

As another non-limiting example of a method for determining a geographic location of the potential domain name registrant 100, the domain name registrar 140 may determine an area code associated with the client device 110. The domain name registrar 140 may determine an area code location for the area code associated with the client device 110. The domain name registrar 140 may then associate the area code location with a geographic location of the potential domain name registrant 100.

The one or more geographic locations determined for the potential domain name registrant 100 may have boundaries of any desired size and shape. As non- limiting examples, the geographic location(s) of the potential domain name registrant 100 may be expressed as a continent, a country, a city, a part of a city, an IP location and/or an area code.

The domain name registrant may thus have one or more geographic locations associated with the domain name registrant. This may be very useful in analyzing one or more restricted domain names. The domain name registrar 140 may include a history data 150 comprising success and/or failure data of a plurality of past restricted domain name requesters at various geographic locations (including the geographic locations of the potential domain name registrant 100). The history data 150 may be organized and stored in any desired manner.

The domain name registrar 140 may create and maintain the history data 150 by storing additional data in the history data 150 as other domain name requesters attempt to register restricted domain names. The successes and/or failures may be tracked along with the requested restricted TLD and the geographic location(s) of the domain name requesters.

The history data 150, once created, may be used to provide statistical data that may be used to predict whether a potential domain name registrant 100 located in a particular continent, country, city, part of a city and/or area code (geographic location) will be able to qualify for one or more restricted domain names.

As a non-limiting example, it may be found that potential domain name registrants 100 that are located in the continent of Asia are rarely able to qualify for restricted domain names that have the restricted TLD of .ca which requires a Canadian presence. Thus, potential domain name registrants 100 with a geographic location of Asia would not be transmitted a suggested restricted domain name having a TLD of .ca. On the other hand, potential domain name registrants 100 that are determined to be located in Canada may be transmitted suggested restricted domain names with the restricted TLD of .ca.

As another non-limiting example, it may be determined from the history data 150 that potential domain name registrants 100 located in a first city within a first country are often able to qualify for a country code in a second country while potential domain name registrants 100 in a second city in the first country are often not able to qualify for the country code in the second country. These idiosyncrasies may be due to various economic ties and business centers between the different countries.

As another non-limiting example, it may be determined from the history data 150 that potential domain name registrants 100 located in a first part of a city within a first country are often able to qualify for a country code in a second country while potential domain name registrants 100 in a second part of the city within the first country are often not able to qualify for the country code in the second country. These idiosyncrasies may be due to various economic ties between different countries and the different business ties and business centers even between different parts of the same city.

As another non-limiting example, it may be determined from the history data 150 that potential domain name registrants 100 located in Washington DC are often able to qualify for restricted domain names that include the restricted TLD of .mil (restricted to the United States military) while potential domain name registrants 100 located anywhere else in the world are never able to qualify for those restricted domain names.

The domain name registrar 140 may use one or more geographic locations of a potential domain name registrant 100 and optionally a domain name search request to select one or more suggested restricted domain names. The suggested restricted domain names may have a restriction for registrants and the geographic location(s) of the potential domain name registrant 100 may be used to predict whether or not the potential domain name registrant 100 will be able to qualify to register one or more of the suggested restricted domain names. (Step 230)

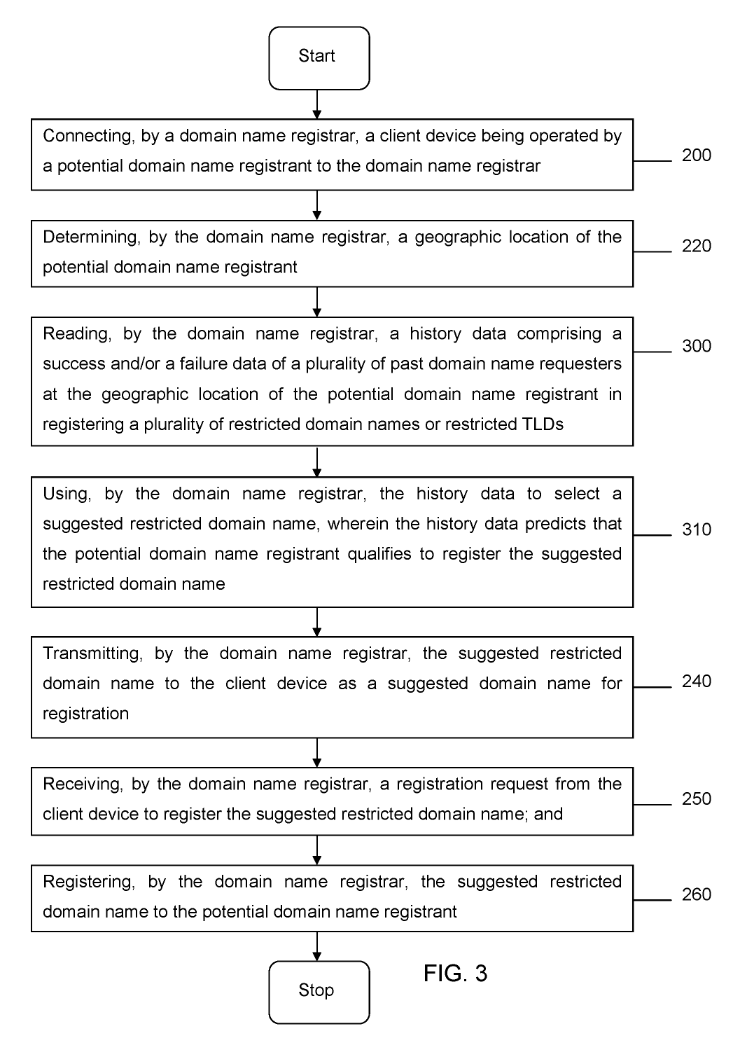

With reference to FIG. 3, the domain name registrar 140 may read a history data 150 comprising a success and/or a failure data of a plurality of past restricted domain name requesters at the geographic location(s) of the potential domain name registrant 100 in registering a plurality of restricted domain names or restricted TLDs. (Step 300)

The domain name registrar 140 may use the history data 150 to select a suggested restricted domain name. The suggested restricted domain name may have a restriction (such as a geographic restriction) for registrants. The history data 150 may be used to predict whether or not the potential domain name registrant 100 qualifies to register the suggested restricted domain name. (Step 310)

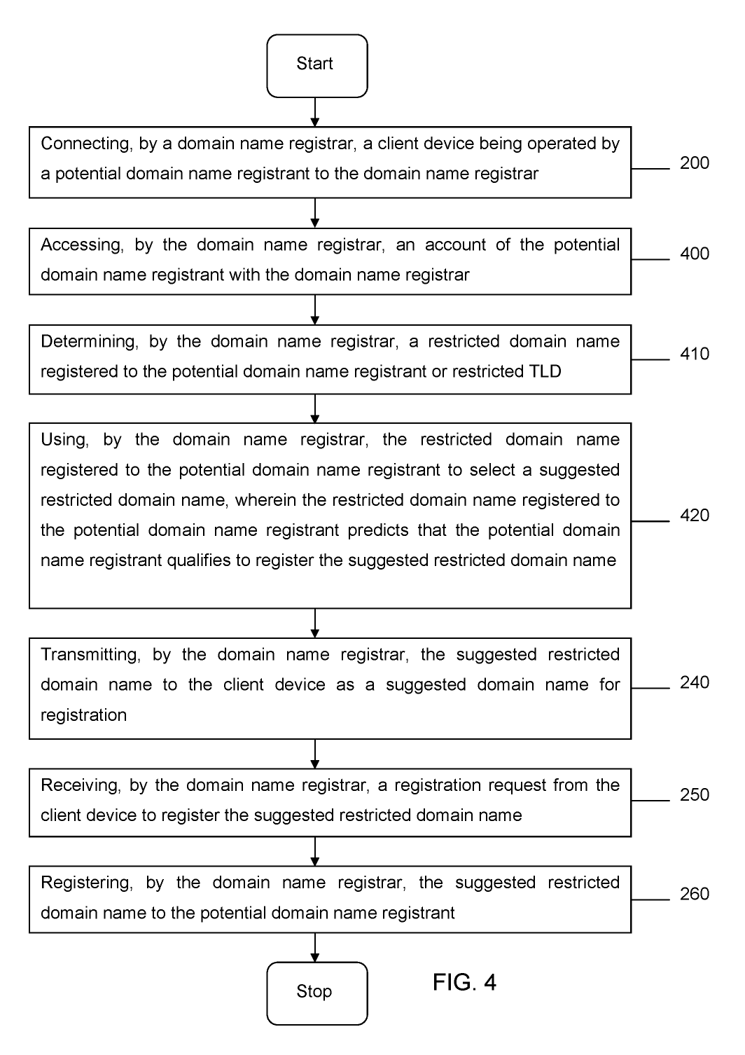

With reference to FIG. 4, the domain name registrar 140 may also determine one or more restricted domain names (having one or more restricted TLDs) registered to the potential domain name registrant 100. The domain name registrar 140 may access an account of the potential domain name registrant 100 with the domain name registrar 140. (Step 400) The domain name registrar 140 may read from the potential domain name registrant account 180 to determine which restricted domain names (or restricted TLDs) the potential domain name registrant 100 has ever registered, if any. (Steps 410) In addition, the domain name registrar 140 may read a business name, a business category and/or a customer profession, i.e., account information, from the potential domain name registrant account 180.

The domain name registrar 140 may use the restricted domain name(s) registered to the potential domain name registrant 100 and/or account information to select one or more suggested restricted domain names. In other words, the restricted domain name(s) registered to the potential domain name registrant 100 and/or account information may be used to predict whether or not the potential domain name registrant 100 will be able to qualify to register the suggested restricted domain names. (Step 420) As a specific example, if a potential domain name registrant 100 previously registered (and thus previously qualified to register) a restricted domain name having a restricted TLD of .edu, then other restricted domain names having TLDs of .edu may be suggested to the potential domain name registrant 100.

The domain name registrar 140 may transmit one or more suggested restricted domain names (possibly with other suggested domain names that are not restricted) to the potential domain name registrant 100. (Step 240) The domain name registrar 140 may or may not receive a request from the potential domain name registrant 100 to register the suggested restricted domain name. (Step 250) If the domain name registrar 140 receives a registration request for the suggested restricted domain name from the potential domain name registrant 100, the domain name registrar 140 may register the suggested restricted domain name to the potential domain name registrant 100.

In an example embodiment, the domain name registrar 140 may collect additional information from the potential domain name registrant 100 to qualify the potential domain name registrant 100 for registering the suggested restricted domain name. If the potential domain name registrant 100 qualifies for the suggested restricted domain name, the domain name registrar 140 may complete a purchase transaction with the potential domain name registrant 100 and then the domain name registrar 140 may register the suggested restricted domain name to the potential domain name registrant 100.

In another embodiment, the domain name registrar 140 may complete a purchase transaction with the potential domain name registrant 100 before collecting additional information from the potential domain name registrant 100 to qualify for the suggested restricted domain name. In this embodiment, only after completing the purchase transaction does the domain name registrar 140 may collect additional information from the potential domain name registrant 100 to qualify the potential domain name registrant 100 for registering the suggested restricted domain name. Collecting the additional information after the purchase may encourage the potential domain name registrant 100 to complete the registration process. If the potential domain name registrant 100 qualifies for the suggested restricted domain name, the domain name registrar 140 may register the suggested restricted domain name to the potential domain name registrant 100. If the potential domain name registrant 100 does not qualify for the suggested restricted domain name, the domain name registrar 140 may reverse the purchase of the suggested restricted domain name with the potential domain name registrant 100.

Other embodiments and uses of the above inventions will be apparent to those having ordinary skill in the art upon consideration of the specification and practice of the invention disclosed herein. It should be understood that features listed and described in one embodiment may be used in other embodiments unless specifically stated otherwise. The specification and examples given should be considered exemplary only, and it is contemplated that the appended claims will cover any other such embodiments or modifications as fall within the true scope of the invention.

The invention claimed is:

1. A method, comprising the steps of:
connecting, by a domain name registrar, a client device being operated by a potential domain name registrant to the domain name registrar;
receiving, by the domain name registrar, a domain name search request from the client device;
determining, by the domain name registrar, a geographic location of the potential domain name registrant;
using, by the domain name registrar, the domain name search request and the geographic location of the potential domain name registrant to select a suggested restricted domain name, wherein the suggested restricted domain name has a restriction for registrants and wherein the geographic location of the potential domain name registrant predicts that the potential domain name registrant qualifies to register the suggested restricted domain name;
transmitting, by the domain name registrar, the suggested restricted domain name to the client device as a suggested domain name for registration;
receiving, by the domain name registrar, a registration request from the client device to register the suggested restricted domain name; and
registering, by the domain name registrar, the suggested restricted domain name to the potential domain name registrant.

2. The method of claim 1, wherein the step of determining the geographic location of the potential domain name registrant comprises the steps of:
accessing, by the domain name registrar, an account of the potential domain name registrant with the domain name registrar;
reading, by the domain name registrar, an address in the account associated with the potential domain name registrant; and
associating, by the domain name registrar, the address in the account with the geographic location of the potential domain name registrant.

3. The method of claim 1, wherein the step of determining the geographic location of the potential domain name registrant comprises the steps of:
reading, by the domain name registrar, an IP address used by the client device to connect to the domain name registrar;
determining, by the domain name registrar, an IP geographic location for the IP address; and
associating, by the domain name registrar, the IP geographic location with the geographic location of the potential domain name registrant.

4. The method of claim 1, wherein the step of determining the geographic location of the potential domain name registrant comprises the steps of:
determining, by the domain name registrar, a cell tower used by the client device to connect to the domain name registrar;
determining, by the domain name registrar, a cell tower location for the cell tower used by the client device; and
associating, by the domain name registrar, the cell tower location with the geographic location of the potential domain name registrant.

5. The method of claim 1, wherein the step of determining the geographic location of the potential domain name registrant comprises the steps of:
determining, by the domain name registrar, an area code used by the client device to connect to the domain name registrar;
determining, by the domain name registrar, an area code location for the area code associated with the client device; and
associating, by the domain name registrar, the area code location with the geographic location of the potential domain name registrant.

6. The method of claim 1, further comprising the step of:
after completing a purchase of the suggested restricted domain name by the potential domain name registrant with the domain name registrar and prior to registering the suggested restricted domain name to the potential domain name registrant, collecting, by the domain name registrar, information from the potential domain name registrant sufficient to qualify the potential domain name registrant for registering the suggested restricted domain name. A method, comprising the steps of:
connecting, by a domain name registrar, a client device being operated by a potential domain name registrant to the domain name registrar;
determining, by the domain name registrar, a geographic location of the potential domain name registrant;
reading, by the domain name registrar, a history data comprising a success and/or a failure data of a plurality of past restricted domain name requesters at the geographic location of the potential domain name registrant in registering a plurality of restricted domain names or restricted TLDs;
using, by the domain name registrar, the history data to select a suggested restricted domain name, wherein the suggested restricted domain name has a geographic restriction for registrants and wherein the history data predicts that the potential domain name registrant qualifies to register the suggested restricted domain name;
transmitting, by the domain name registrar, the suggested restricted domain name to the client device as a suggested domain name for registration;
receiving, by the domain name registrar, a registration request from the client device to register the suggested restricted domain name; and
registering, by the domain name registrar, the suggested restricted domain name to the potential domain name registrant.

8. The method of claim 7, wherein the geographic location of the potential domain name registrants is a country.

9. The method of claim 7, wherein the geographic location of the potential domain name registrants is a city.

10. The method of claim 7, wherein the geographic location of the potential domain name registrants is an area code of a phone number associated with the client device.

11. The method of claim 7, wherein the step of determining the geographic location of the potential domain name registrant comprises the steps of:
accessing, by the domain name registrar, an account of the potential domain name registrant with the domain name registrar;
reading, by the domain name registrar, an address in the account associated with the potential domain name registrant; and
associating, by the domain name registrar, the address in the account with the geographic location of the potential domain name registrant.

12. The method of claim 7, wherein the step of determining the geographic location of the potential domain name registrant comprises the steps of:
reading, by the domain name registrar, an IP address used by the client device to connect to the domain name registrar;
determining, by the domain name registrar, an IP geographic location for the IP address; and
associating, by the domain name registrar, the IP geographic location with the geographic location of the potential domain name registrant.

13. The method of claim 7, wherein the step of determining the geographic location of the potential domain name registrant comprises the steps of:
determining, by the domain name registrar, a cell tower used by the client device to connect to the domain name registrar;
determining, by the domain name registrar, a cell tower location for the cell tower associated with the client device; and
associating, by the domain name registrar, the cell tower location with the geographic location of the potential domain name registrant.

14. The method of claim 7, wherein the step of determining the geographic location of the potential domain name registrant comprises the steps of:
determining, by the domain name registrar, an area code used by the client device to connect to the domain name registrar;
determining, by the domain name registrar, an area code location for the area code used by the client device; and
associating, by the domain name registrar, the area code location with the geographic location of the potential domain name registrant.

15. The method of claim 7, further comprising the step of:
after completing a purchase of the suggested restricted domain name by the potential domain name registrant with the domain name registrar and prior to registering the suggested restricted domain name to the potential domain name registrant, collecting, by the domain name registrar, information from the potential domain name registrant sufficient to qualify the potential domain name registrant for registering the suggested restricted domain name.

16. A method, comprising the steps of:
connecting, by a domain name registrar, a client device being operated by a potential domain name registrant to the domain name registrar;
accessing, by the domain name registrar, an account of the potential domain name registrant with the domain name registrar;
determining, by the domain name registrar, a restricted domain name registered to the potential domain name registrant;
using, by the domain name registrar, the restricted domain name registered to the potential domain name registrant to select a suggested restricted domain name, wherein the suggested restricted domain name has a restriction for registrants and wherein the restricted domain name registered to the potential domain name registrant predicts that the potential domain name registrant qualifies to register the suggested restricted domain name;
transmitting, by the domain name registrar, the suggested restricted domain name to the client device as a suggested domain name for registration;
receiving, by the domain name registrar, a registration request from the client device to register the suggested restricted domain name; and
registering, by the domain name registrar, the suggested restricted domain name to the potential domain name registrant.

17. The method of claim 16, wherein the restricted domain name registered to the potential domain name registrant and the suggested restricted domain name transmitted to the client device comprise the same restricted Top-Level Domain.

18. The method of claim 16, further comprising the step of:
using, by the domain name registrar, the restricted domain name registered to the potential domain name registrant to intentionally not select a second suggested restricted domain name, wherein the restricted domain name registered to the potential domain name registrant predicts that the potential domain name registrant does not qualify to register the second suggested restricted domain name.

19. The method of claim 16, further comprising the step of:
after completing a purchase of the suggested restricted domain name by the potential domain name registrant with the domain name registrar and prior to registering the suggested restricted domain name to the potential domain name registrant, collecting, by the domain name registrar, information from the potential domain name registrant sufficient to qualify the potential domain name registrant for registering the suggested restricted domain name.

20. The method of claim 16, further comprising the step of:
before completing a purchase of the suggested restricted domain name by the potential domain name registrant with the domain name registrar, collecting, by the domain name registrar, information from the potential domain name registrant sufficient to qualify the potential domain name registrant for registering the suggested restricted domain name.
